(19) United States
(12) Patent Application Publication
(10) Pub. No.: US 2007/0008480 A1
(43) Pub. Date: Jan. 11, 2007

(54) Liquid crystal display

(75) Inventors: Sung-Hwan Hong, Suwon-si (KR); Myeong-Ha Kye, Seoul (KR); Kwang-Hyun Kim, Guri-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/482,017

(22) Filed: Jul. 6, 2006

(30) Foreign Application Priority Data
Jul. 11, 2005 (KR) 10-2005-0062266
Jul. 12, 2005 (KR) 10-2005-0062742

(51) Int. Cl. C09K 19/02

(52) U.S. Cl. 349/179

(57) ABSTRACT

A liquid crystal display (LCD) includes a first electrode, a second electrode facing the first electrode, and a liquid crystal layer interposed between the first and second electrodes and having a twisted nematic alignment of liquid crystals, wherein rotation viscosity of the liquid crystal layer is 50 mPas-80 mPas, a cell gap, namely, the thickness of the liquid crystal layer, is 2.5 μm-5.0 μm, a voltage difference between the first and second electrodes is 0.2V-8.0V, and a response time can be obtained from the expression 6.78+(rotation viscosity)×0.81+(cell gap)×0.7+(rotation viscosity)×(cell gap)×0.14. The liquid crystal display having the twisted nematic alignment of liquid crystals, has the pitch of the liquid crystal layer within the range of 10 μm to 70 μm, a cell gap, namely, the thickness of the liquid crystal layer, within the range of 3.0 μm to 4.5 μm, and a voltage difference between the first and second electrodes within the range of 0.2V to 6.0V.

### CROSS-REFERENCE TO RELATED APPLICATION

This application claims priority to and the benefit of Korean Patent Application No. 10-2005-0062266 filed in the Korean Intellectual Property Office on Jul. 11, 2005 and the benefit of Korean Patent Application No. 10-2005-0062742 filed in the Korean Intellectual Property Office on Jul. 12, 2005, the entire contents of which are incorporated herein by reference.

### BACKGROUND OF THE INVENTION

(a) Technical Field

The present disclosure relates to a liquid crystal display (LCD) and, more particularly, to a twisted nematic (TN) mode LCD.

(b) Description of the Related Art

In general, an LCD includes a liquid crystal layer positioned between a pair of display panels with a field generating electrode and a polarizer provided thereon. The field generating electrode generates an electric field with respect to the liquid crystal layer and, as the strength of the electric field changes, alignment of the liquid crystal molecules varies. For example, in a state where an electric field is applied, the liquid crystal molecules of the liquid crystal layer have their alignment changed to thereby change polarization of light that passes through the liquid crystal layer. A polarizer generates a bright or dark region by appropriately blocking or transmitting the polarized light passing therethrough to thereby allow a desired image to be displayed.

LCDs can be divided into several types depending on how the liquid crystal molecules are aligned, including, for example, a TN mode LCD, an in-plane switching (IPS) mode LCD, and a vertical alignment (VA) mode LCD. Of these, the TN mode LCD is most generally used.

The above information disclosed in this Background section is only for enhancement of understanding of the background of the invention and therefore it may contain information that does not form the prior art that is already known in this country to a person of ordinary skill in the art.

### SUMMARY OF THE INVENTION

An exemplary embodiment of the present invention provides a liquid crystal display (LCD) including a first electrode, a second electrode facing the first electrode, and a liquid crystal layer interposed between the first and second electrodes and having a twisted nematic alignment of liquid crystals, wherein rotation viscosity of the liquid crystal layer is within a range of about 50 mPas to about 80 mPas, a cell gap defining the thickness of the liquid crystal layer is within a range of about 2.5 μm to about 5.0 μm, and a voltage difference between the first and second electrodes is within a range of about 0.2V to about 8.0V.

When the rotation viscosity is about 75 mPas, the response time of the liquid crystal layer can be determined by the expression −2.3×(cell gap)²+17.83×(cell gap)−26.04.

When the rotation viscosity is about 65 mPas, the response time of the liquid crystal layer can be determined by the expression −0.42×(cell gap)²+3.95×(cell gap)−2.25.

When the rotation viscosity is about 50 mPas, the response time of the liquid crystal layer can be determined by the expression 0.95×(cell gap)²−5.525×(cell gap)+13.43.

An embodiment of the present invention provides a liquid crystal display (LCD) including a first electrode, a second electrode facing the first electrode, and a liquid crystal layer interposed between the first and second electrodes and having a twisted nematic alignment of liquid crystals, wherein rotation viscosity of the liquid crystal layer is about 50 mPas-80 mPas, a cell gap defining the thickness of the liquid crystal layer is about 2.5 μm-5.0 μm, a voltage difference between the first and second electrodes is about 0.2V-8.0V, and a response time can be determined by the expression 6.78+(rotation viscosity)×0.81+(cell gap)×0.7+(rotation viscosity)×(cell gap)×0.14.

When the rotation viscosity of the liquid crystal layer is within the range of about 50 mPas to 65 mPas, the cell gap is within the range of about 3.2 μm to 3.8 μm.

When the rotation viscosity of the liquid crystal layer exceeds about 65 mPas, but is not greater than about 75 mPas, the cell gap is about 2.6 μm or greater, but smaller than about 3.2 μm.

When the rotation viscosity of the liquid crystal layer is within the range of about 75 mPas to 80 mPas, the cell gap is about 2.5 μm or greater, but smaller than about 2.6 μm.

An embodiment of the present invention provides a liquid crystal display (LCD) including a first electrode, a second electrode facing the first electrode, and a liquid crystal layer interposed between the first and second electrodes and having a twisted nematic alignment of liquid crystals, wherein the pitch of the liquid crystal layer is within a range of about 10 μm to 70 μm, a cell gap defining the thickness of the liquid crystal layer is within a range of about 3.0 μm to 4.5 μm, and a voltage difference between the first and second electrodes is within a range of about 0.2V to 6.0V.

In the LCD, the voltage difference between the first and second electrodes can be within the range of about 0.2V to 5.5V, the pitch of the liquid crystal layer can be within the range of about 10 μm to 30 μm, and a response time of the liquid crystal layer can be determined by the expression 0.0364×pitch+4.9928.

In the LCD, the voltage difference between the first and second electrodes can be within the range of about 0.2V to 5.5V, the pitch of the liquid crystal layer can be within the range of about 30 μm to 70 μm, and the response time of the liquid crystal layer can be determined by the expression 0.0166×pitch+5.5558.

In the LCD, the voltage difference between the first and second electrodes can be within the range of about 0.2V to 6.0V, the pitch of the liquid crystal layer can be within the range of about 10 μm to 30 μm, and the response time of the liquid crystal layer can be determined by the expression 0.0408×pitch+4.8189.

In the LCD, the voltage difference between the first and second electrodes can be within the range of about 0.2V to 6.0V, the pitch of the liquid crystal layer can be within the range of about 30 μm to 70 μm, and the response time of the liquid crystal layer can be determined by the expression 0.0123×(pitch)+5.6467.

In the LCD, the pitch of the liquid crystal layer can be about 20 μm, the contrast ratio of a screen can be about 500:1, and a maximum voltage difference between the first and second electrodes may be greater than about 5.8V.

In the LCD, the pitch of the liquid crystal layer can be about 30 μm, the contrast ratio of a screen can be about 500:1, and a maximum voltage difference between the first and second electrodes may be greater than about 5.4V.

In the LCD, the pitch of the liquid crystal layer can be about 30 μm, the contrast ratio of a screen can be about 600:1, and a maximum voltage difference between the first and second electrodes may be greater than about 5.6V.

The first electrode may include a first substrate, a gate line, and a data line formed on the first substrate, a thin film transistor (TFT) connected with the gate line and the data line, and a pixel electrode connected with the TFT.

The second electrode may include a second substrate, a color filter formed on the second substrate, and a common electrode formed on the color filter.

The second electrode may further include a light blocking member formed on the second substrate.

### BRIEF DESCRIPTION OF THE DRAWINGS

FIG. 1 is a layout view of a liquid crystal display (LCD) in accordance with one exemplary embodiment of the present invention.

FIG. 2 is a cross-sectional view taken along line II-II of the LCD in FIG. 1.

FIG. 3 is a cross-sectional view taken along line III-III of the LCD in FIG. 1.

FIGS. 4a and 4b are cross-sectional views showing operational states of a pixel structure in a twisted nematic (TN) mode LCD according to an exemplary embodiment of the present invention.

FIG. 5 is a table showing response times according to a rotation gamma and a cell gap of the LCD according to an experimentation of the present invention.

FIG. 6 is a graph showing response times of a liquid crystal layer according to a rotation gamma and a cell gap of the LCD according to an experimentation of the present invention.

FIG. 7 is a graph showing response times of a liquid crystal layer according to a change in rotation viscosity with respect to various cell gaps in an experimentation of the present invention.

FIG. 8 is a table showing response times of a liquid crystal layer according to the pitch of the liquid crystal layer of the LCD according to an experimentation of the present invention.

FIG. 9 is a graph showing response times of a liquid crystal layer according to the pitch of the liquid crystal layer according to an experimentation of the present invention.

FIG. 10 is a table showing change of contrast ratio of a screen according to a voltage difference between the pitch of the liquid crystal layer and an electrode.

### DESCRIPTION OF EXEMPLARY EMBODIMENTS

The TN mode LCD has a problem in that because a response time of a liquid crystal layer is delayed by about 20-30 ms, there is a limitation when displaying a motion picture (video).

An embodiment of the present invention provides an LCD having a fast response time of about 5 ms.

With reference to the accompanying drawings, embodiments of the present invention will be described in order for those skilled in the art to be able to implement the invention. As those skilled in the art would realize, the described embodiments may be modified in various different ways, all without departing from the spirit or scope of the present invention.

To clarify multiple layers and regions, the thicknesses of the layers are enlarged in the drawings. Like reference numerals designate like elements throughout the specification. When it is said that any part, such as a layer, film, area, or plate, is positioned on another part, it means the part is directly on the other part or above the other part with at least one intermediate part. On the other hand, if any part is said to be positioned directly on another part it means that there is no intermediate part between the two parts.

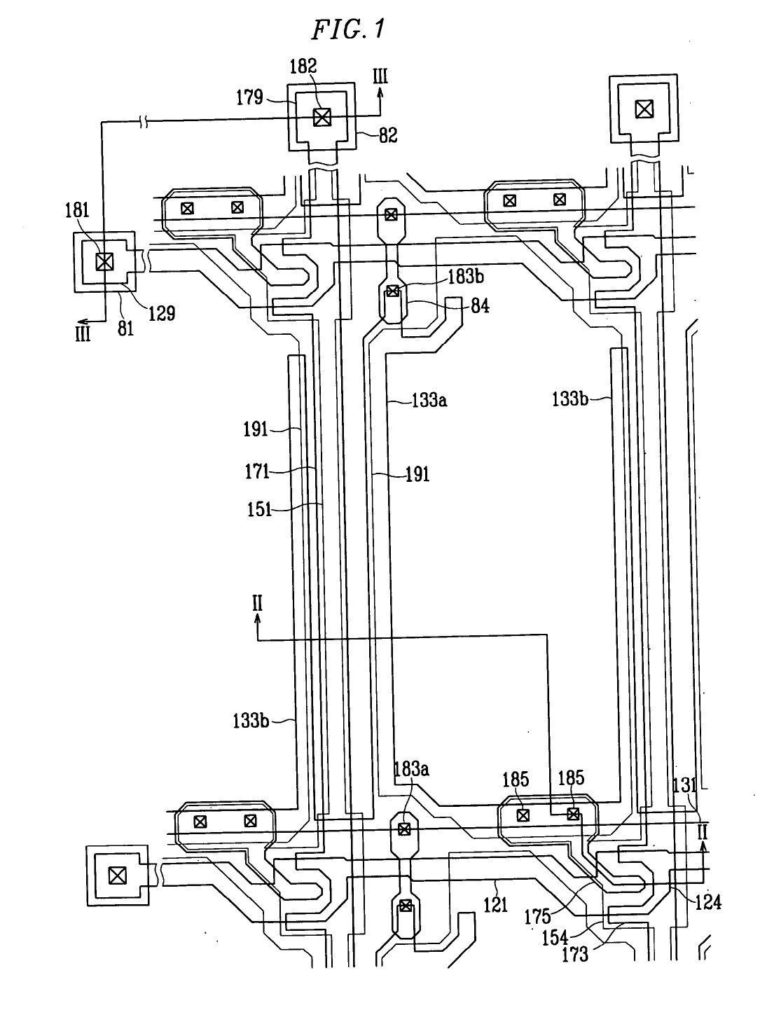

An LCD and a polarizer according to an exemplary embodiment of the present invention will be described in detail with reference to FIGS. 1 to 3.

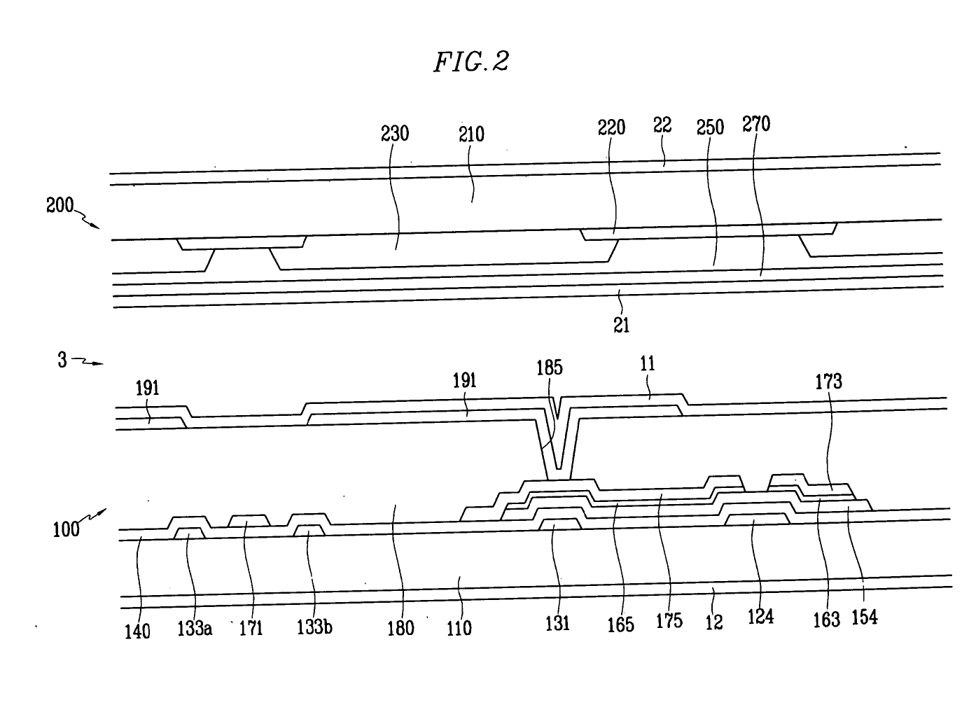

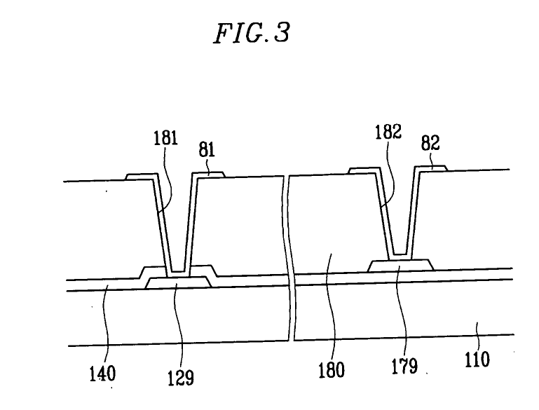

FIG. 1 is a layout view of a liquid crystal display (LCD) in accordance with an exemplary embodiment of the present invention and FIGS. 2 and 3 are cross-sectional views taken along lines II-II and III-III of the LCD in FIG. 1, respectively.

The LCD according to the embodiment comprises a thin film transistor (TFT) array panel 100 and a common electrode panel 200, which are formed to face each other, and a liquid crystal layer 3 interposed between the two display panels 100 and 200.

The TFT array panel of the LCD will now be described in detail with reference to FIGS. 1 to 3.

A plurality of gate lines 121 and a plurality of storage electrode lines 131 are formed on an insulation substrate 110 made of transparent glass or plastic.

The gate lines 121 transfer gate signals and mainly extend in a horizontal direction. Each gate line 121 includes a plurality of gate electrodes 124 projected downwardly and an end portion with a larger area for connection with a different layer or an external driving circuit. A gate driving circuit (not shown) for generating a gate signal can be mounted on a flexible printed circuit (not shown) attached on the substrate 110, mounted directly on the substrate 110, or integrated on the substrate 110. If the gate driving circuit is integrated on the substrate 110, the gate lines 121 can be elongated to be directly connected therewith.

The storage electrode lines 131 receive a predetermined voltage and include a branch line that extends substantially in parallel to the gate lines 121 and pairs of first and second storage electrodes 133a and 133b branched from the branch line. Each storage electrode line 131 is positioned between two adjacent gate lines 121, and the branch line is closer to the lower of the two gate lines 121. The storage electrodes 133a and 133b respectively include a fixed end connected with the branch line and a free end positioned at the opposite side. The fixed end of the first storage electrode 133a has a large area and the free end is bifurcated into a linear portion and a curved portion. However, the storage electrode lines can be modified to have various shapes and dispositions.

The gate lines 121 and the storage electrode lines 131 can be made of an aluminum group metal, such as aluminum (Al) or an aluminum alloy, a silver group metal, such as silver (Ag) or a silver alloy, a copper group metal, such as copper (Cu) or a copper alloy, a molybdenum group metal, such as molybdenum or a molybdenum alloy, chromium (Cr), tantalum (Ta), and titanium (Ti), etc. In this respect, however, the gate lines 121 and the storage electrode lines 131 can have a multi-layer structure including two conductive layers (not shown) each having different physical properties. One of the two conductive layers is made of a metal with low resistivity, for example, an aluminum group metal, a silver group metal, or a copper group metal, to reduce a signal delay or a voltage drop. The other one of the two conductive layers is made of a material, for example, a molybdenum group metal, chromium, tantalum, or titanium, that exhibits excellent physical, chemical, and electrical contact characteristics with a different material in particular with ITO (Indium Tin Oxide) and IZO (Indium Zinc Oxide). Examples of good combinations may include a combination of a chromium lower film and an aluminum (alloy) upper film, and a combination of an aluminum (alloy) lower film and a molybdenum (alloy) upper film. Also, the gate lines 121 and the storage electrode lines 131 can be made of various other metals or conductors.

The sides of the gate lines 121 and the sides of the storage electrode lines 131 are sloped relative to the surface of the substrate 110, and the slope angle is preferably about 30° to 80°.

A gate insulation layer 140 made of silicon nitride (SiNx) or silicon oxide (SiOx), etc., is formed on the gate lines 121 and the storage electrode lines 131.

A plurality of semiconductor stripes 151 made of hydrogenated amorphous silicon (a-Si) or polycrystalline silicon, etc., are formed on the gate insulation layer 140. The semiconductor stripes 151 mainly extend in a vertical direction and include a plurality of projections 154 projected toward the gate electrodes 124. Each semiconductor stripe 151 is increased in its width near the gate line 121 and the storage electrode line 131 to extensively cover them.

A plurality of ohmic contact stripes 161 and a plurality of ohmic contact islands 165 are formed on the semiconductor stripes 151. The ohmic contact stripes 161 and the ohmic contact islands 165 can be made of a material such as n+ hydrogenated amorphous silicon in which an n-type impurity such as phosphor is doped with high density, or can be made of silicide. The ohmic contact stripes 161 include a plurality of projections 163, and the projections 163 and the ohmic contact islands 165 are arranged as pairs on the projections 154 of the semiconductor stripes 151.

The sides of the semiconductor stripes 151 and the sides of the ohmic contact stripes and islands 161 and 165 are also sloped relative to the surface of the substrate 10, and the slope angle is about 30° to 80°.

A plurality of data lines 171 and a plurality of data electrodes 175 are formed on the ohmic contact stripes and islands 161 and 165 and the gate insulation layer 140.

The data lines 171 transfer a data signal and mainly extend in a vertical direction to cross the gate lines 121. Each data line 171 crosses a storage electrode line 131 and runs between a set of adjacent storage electrodes 133a and 133b. Each data line 171 includes a plurality of source electrodes 173 extending toward the gate electrodes 124 and an end portion 179 with a wide area for connection with a different layer or an external driving circuit. A data driving circuit (not shown) for generating a data signal can be mounted on a flexible printed circuit film (not shown) attached to the substrate 110, mounted directly on the substrate 110, or integrated on the substrate 110. In the case where the data driving circuit is integrated on the substrate 110, the data lines 171 can be elongated to be connected therewith.

The drain electrodes 175 are separated from the data lines 171 and face the source electrodes 173 centering around the gate electrodes 124. Each drain electrode 175 includes one end portion that is large and one end portion that has a bar shape. The large end portion overlaps with a storage electrode 137, and the bar-shaped end portion is partially surrounded by a source electrode 173 bent in a ‘J’ shape.

One gate electrode 124, one source electrode 173, and one drain electrode 175 constitute a thin film transistor (TFT) together with the projection 154 of the semiconductor stripe 151, and a channel of the TFT is formed at the projection 154 between the source electrode 173 and the drain electrode 175.

Preferably, the drain lines 171 and the drain electrodes 175 are made of a refractory metal, such as molybdenum, chromium, tantalum, and titanium, or their alloys, and can have a multi-layer structure including a refractory metal film (not shown) and a low-resistance conductive layer (not shown). Examples of the multi-layer structure can include a double-layer of a chromium or molybdenum (alloy) lower film and an aluminum (alloy) upper film, and a triple-layer of a molybdenum (alloy) lower film, an aluminum (alloy) intermediate layer, and a molybdenum (alloy) upper film. Also, the data lines 171 and the drain electrodes 175 can be made of various other metals or conductors.

Preferably, the sides of the data lines 171 and the sides of the drain electrodes 175 are sloped relative to the surface of the substrate 110 at a slope angle of about 30° to 80°.

The ohmic contact stripes and islands 161 and 165 exist only between the lower semiconductor stripes 151 and the upper data lines 171 and drain electrodes 175 to lower contact resistance therebetween. The majority of each semiconductor stripe 151 is narrower than the data line 171, but as afore-mentioned, the portion of the semiconductor stripe 151 that meets the gate line 121 has a large width, smoothing a profile of the surface, so that disconnection of the data line 171 can be prevented. Some portions of each semiconductor stripe 151, including, for example, the portion between the source electrode 173 and the drain electrode 175, are exposed, without being covered by the data line 171 and the drain electrode 175.

A passivation layer 180 is formed on the data lines 171, the drain electrodes 175, and the exposed portions of the semiconductor stripes 151. The passivation layer 180 is made of an inorganic insulator or an organic insulation material, etc., and can have a planarized surface. Examples of an inorganic insulator can be silicon nitride and silicon oxide. The organic insulator can have photosensitivity, and preferably, its dielectric constant is not greater than about 4.0. In this respect, the passivation layer 180 can also have a dual-layer structure of a lower inorganic film and an upper organic film so that it may not do harm to the exposed portion of the semiconductor stripe 151 while still sustaining the excellent insulation characteristics of the organic film.

At the passivation layer 180 there are formed a plurality of contact holes 182 and 185 exposing the end portions 179 of the data lines 171 and the drain electrodes 175, respectively, and at the passivation layer 180 and the gate insulating layer 140 there are formed a plurality of contact holes 181 exposing the end portions 129 of the gate lines 121, a plurality of contact holes 183a exposing portions of the storage electrode lines 131 near the fixed ends of the first storage electrodes 133a, and a plurality of contact holes 183b exposing the projections of the free ends of the first storage electrodes 133a.

A plurality of pixel electrodes 191, a plurality of overpasses 84, and a plurality of contact assistants 81 and 82 are formed at an upper portion of the passivation layer 180. The pixel electrodes 191 and the contact assistants 81 and 82 can be made of a transparent conductive material such as ITO or IZO, or a reflexive metal, such as aluminum, silver, chromium, or their alloys.

The pixel electrode 191 is physically and electrically connected with the drain electrode 175 through the contact hole 185, and receives a data voltage from the drain electrode 175. Upon receiving the data voltage, the pixel electrode 191 generates an electric field together with a common electrode 270 of the common electrode display panel 200 which receives a common voltage, to thereby determine a direction of the liquid crystal molecules (not shown) of the liquid crystal layer 3 between the two electrodes 191 and 270. Polarization of light that transmits through the liquid crystal layer can be varied according to the determined direction of the liquid crystal molecules. The pixel electrode 191 and the common electrode 270 form a capacitor, referred to hereinafter as ‘liquid crystal capacitor’, to sustain the applied voltages even after the TFT is turned off.

The pixel electrode overlaps with the storage electrode line 131 as well as with the storage electrodes 133a and 133b. A capacitor, formed where the pixel electrode 191 and the drain electrode 175 electrically connected to the pixel electrode 191 overlap with the storage electrode line 131, is called a storage capacitor, and the storage capacitor strengthens a voltage-sustaining capability of the liquid crystal capacitor.

The contact assistants 81 and 82 are connected with the end portion 129 of the gate line 121 and the end portion 179 of the data line 171 through the contact holes 181 and 182, respectively. The contact assistants 81 and 82 complement bonding characteristics of the end portion 129 of the gate line 121 and the end portion 179 of the data line 171 with an external device, and protect them. The overpass 84, traversing the gate line 121, is connected with the exposed portion of the storage electrode line 131 and the exposed end portion of the free end of the storage electrode 133b via the contact holes 183a and 183b positioned at the other side of the gate line 121. The storage electrode line 131 as well as the storage electrodes 133a and 133b can be used together with the overpass 84 to repair a defect of the gate line 121, the data line 171, or the TFT.

The common electrode panel 200 will now be described with reference to FIGS. 2 and 3.

A light blocking member 220 is formed on the insulation substrate 210 made of transparent glass or the like. The light blocking member 220 is also called a black matrix and prevents light leakage. The light blocking member 220 faces the pixel electrodes 191, includes a plurality of openings having substantially the same shape as the pixel electrodes 191, and prevents light leakage between the pixel electrodes is 191. The light blocking member 220 can comprise a portion corresponding to the gate line 121 and the data line 171 and a portion corresponding to the TFT.

A plurality of color filters 230 are also formed on the substrate 210. The color filters 230 are mostly positioned inside a region surrounded by the light blocking member 220, and can extend along a vertical direction along the column of the pixel electrodes 191. Each color filter 230 can display one of the primary colors, i.e., red, green, or blue.

An overcoat 250 is formed on the color filters 230 and the light blocking members 220. The overcoat 250 can be made of an (organic) insulator, prevents the color filters 230 from being exposed, and provides a planarized surface. The overcoat 250 can be omitted.

A common electrode 270 is formed on the overcoat 250. The common electrode 270 is made of a transparent conductor such as ITO, IZO, or the like.

Alignment layers 11 and 21 are respectively coated on each of the inner surfaces of the two display panels 100 and 200, and polarizers 12 and 22 are attached on each of the outer surfaces of the two display panels 100 and 200.

Transmissive axes of the two polarizers 12 and 22 are perpendicular or parallel to each other

In the case of a reflective LCD, one of the two polarizers 12 and 22 can be omitted.

The LCD may further comprise a backlight unit (not shown) for supplying light to the phase retardation film, the display panels 100 and 200, and the liquid crystal layer 3.

The liquid crystal layer 3 comprises a nematic liquid crystal material having a positive dielectric anisotropy. Regarding the liquid crystal molecules of the liquid crystal layer 3, the liquid crystal molecules are arranged such that their longer axes are parallel to the display panels 100 and 200 and they are spirally twisted by 90° starting from one display panel 100 to reach the other display panel 200.

Preferably, rotation viscosity of the liquid crystal layer 3 is 50 mPas-80 mPas or greater, a dielectric anisotropy of the liquid crystal layer 3 is 4.8-5.5, a cell gap is 2.5 μm-5.0 μm, and a voltage difference between the two electrodes 191 and 270 is within the range of 0.2V to 8.0V. Preferably, a response time of the liquid crystal layer can be obtained from the expression 6.78+(rotation viscosity)×0.81+(cell gap)×0.7+(rotation viscosity)×(cell gap)×0.14.

If the rotation viscosity is 75 mPas, the response time of the liquid crystal layer can be obtained from the expression −2.3×(cell gap)²+17.83×(cell gap)−26.04. If the rotation viscosity is 65 mPas, the response time of the liquid crystal layer can be obtained from the expression −0.42×(cell gap)²+3.95×(cell gap)−2.25. If the rotation viscosity is 50 mPas, the response time of the liquid crystal layer can be obtained from the expression 0.95×(cell gap)²−5.525×(cell gap)+13.43.

If the rotation viscosity of the liquid crystal layer 3 is within the range of 50 mPas to 65 mPas, the cell gap is preferably within the range of 3.2 μm to 3.8 μm. If the rotation viscosity of the liquid crystal layer 3 exceeds 65 mPas, but is 75 mPas or less, the cell gap is preferably 2.6 μm or greater, but smaller than 3.2 μm. If the rotation viscosity of the liquid crystal layer 3 exceeds 75 mPas, but is not greater than 80 mPas, the cell gap is preferably 2.5 μm or greater, but smaller than 2.6 μm.

The rotation viscosity of the liquid crystal layer 3 is preferably within the range of 50 mPas-60 mPas, the pitch of the liquid crystal layer 3 is preferably within the range of 10 μm-70 μm, the cell gap is preferably within the range of 3.0 μm-4.5 μm, and the voltage difference between the two electrodes 191 and 270 is preferably within the range of 0.2V to 6.0V.

If the voltage difference between the two electrodes 191 and 270 is within the range of 0.2V-5.5V and the pitch of the liquid crystal layer 3 is within the range of 10 μm to 30 μm, the response time of the liquid crystal layer can be obtained from the expression 0.0364×(pitch)+4.9928. If the voltage difference between the two electrodes 191 and 270 is within the range of 0.2V to 6.0V and the pitch of the liquid crystal layer 3 is within the range of 10 μm-30 μm, the response time of the liquid crystal layer can be obtained from the expression 0.0408×(pitch)+4.8189. If the voltage difference between the two electrodes 191 and 270 is within the range of 0.2V to 6.0V and the pitch of the liquid crystal layer 3 is within the range of 30 μm-70 μm, the response time of the liquid crystal layer can be obtained from the expression 0.0123×(pitch)+5.6467.

In order to ensure a quick response time of the liquid crystal and to sustain the contrast ratio of a screen above a certain level, preferably, the voltage difference between the field generating electrodes is controlled according to the pitch of the liquid crystal 3.

If the pitch of the liquid crystal layer 3 is 20 μm and the contrast ratio of the screen is 500:1, a maximum voltage difference between the electrodes 191 and 270 is preferably greater than 5.8V. If the pitch of the liquid crystal layer 3 is 30 μm and the contrast ratio of the screen is 500:1, the maximum voltage difference between the two electrodes 191 and 270 is preferably greater than 5.4V. If the pitch of the liquid crystal layer 3 is 30 μm and the contrast ratio of the screen is 600:1, the maximum voltage difference between the electrodes 191 and 270 is preferably greater than 5.6V.

When the liquid crystal layer 3 is fabricated with such dimensions, it can obtain a relatively short response time of 5 ms or less.

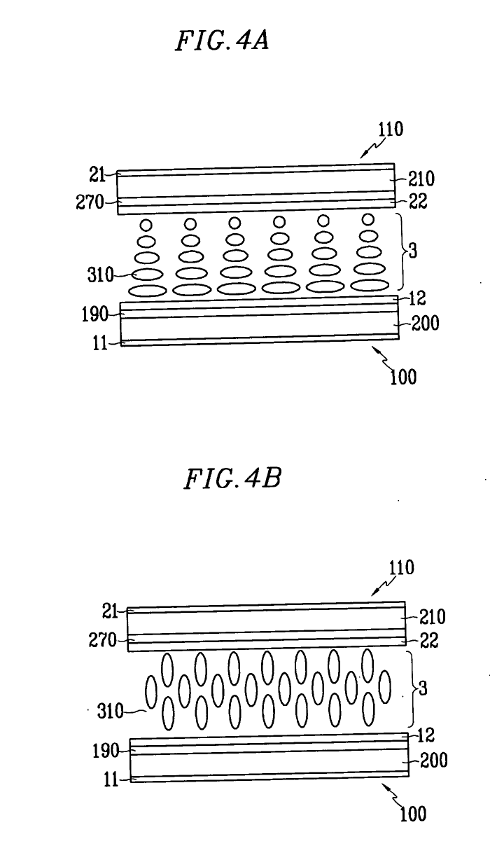

The operation of the LCD according to the present exemplary embodiment will now be described with reference to FIGS. 4A and 4B.

FIGS. 4A and 4B are cross-sectional views showing alignments of liquid crystal molecules in the TN LCD according to the exemplary embodiment of the present invention.

When there is no voltage difference between the pixel electrode 191 and the common electrode 270, namely, between the field generating electrodes 191 and 270, and so there is no electric field applied to the liquid crystal layer 3, as shown in FIG. 4A, the liquid crystal molecules 31 of the liquid crystal layer 3 are arranged such that their longer axes are parallel to the surface of the display panels 100 and 200 and have such a structure that they are spirally twisted by 90° starting from the one display panel 100 up to the other display panel 200.

When light passes through the polarizer 12, it is linearly polarized, and when the linearly polarized light passes through the liquid crystal layer 3, it changes due to retardation owing to a refractive anisotropy of the liquid crystals. By controlling the dielectric anisotropy and the spiral pitch of the liquid crystal layer 3 or the cell gap that is, the thickness of the liquid crystal layer 3, between the display panels 100 and 200, the linear polarization direction of light that has passed through the liquid crystal layer 3 can be rotated by 90°.

Thus, when the transmissive axes of the polarizers 12 and 22 are perpendicular to each other, the light that has passed through the liquid crystal layer 3 can pass through the polarizer 22 as it is, implementing a bright state, which is called a normally white mode. On the other hand, when the transmissive axes of the two polarizers 12 and 22 are parallel to each other, the light that has passed through the liquid crystal layer 3 is blocked by the polarizer 22, implementing a dark state, which is called a normally black mode.

With reference to FIG. 4B, when an electric field with a sufficient size is formed by generating a voltage difference between the field generating electrodes 191 and 270, the liquid crystal molecules 31 are arranged such that their longer axes are parallel with the direction of the electric field and vertical with respect to the display panels 100 and 200.

At this time, the light that has passed through the polarizer 12 passes through the liquid crystal layer 3 without any change in its polarization. Accordingly, in the normally white mode, light that has passed through the liquid crystal layer 3 is blocked by the polarizer 22, implementing the dark state, while in the normally black mode, light that has passed through the polarizer 12 passes through the polarizer 22 as it is, implementing the bright state.

The response time of the liquid crystal layer 3 is divided into a rising time and a falling time. The rising time refers to a response time during which liquid crystals react when a voltage with a sufficient size is applied in a state that no voltage has been applied between the field generating electrodes 191 and 270, and the falling time refers to a response time during which liquid crystals react when a low voltage is sufficiently applied in a state that the voltage with sufficient size has been applied to the field generating electrodes 191 and 270, namely, a time during which the liquid crystal molecules return to their original state.

The relationship between various characteristics and the response time of the liquid crystal layer will be described in detail in the following.

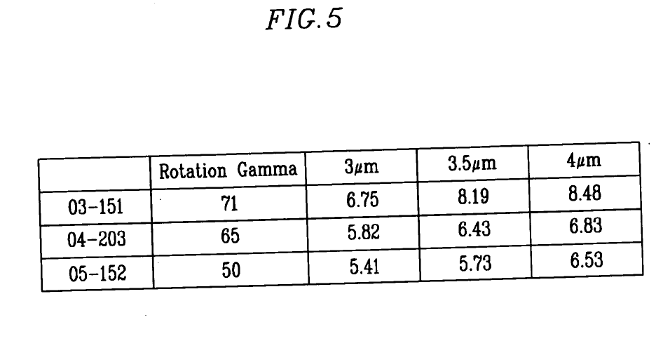

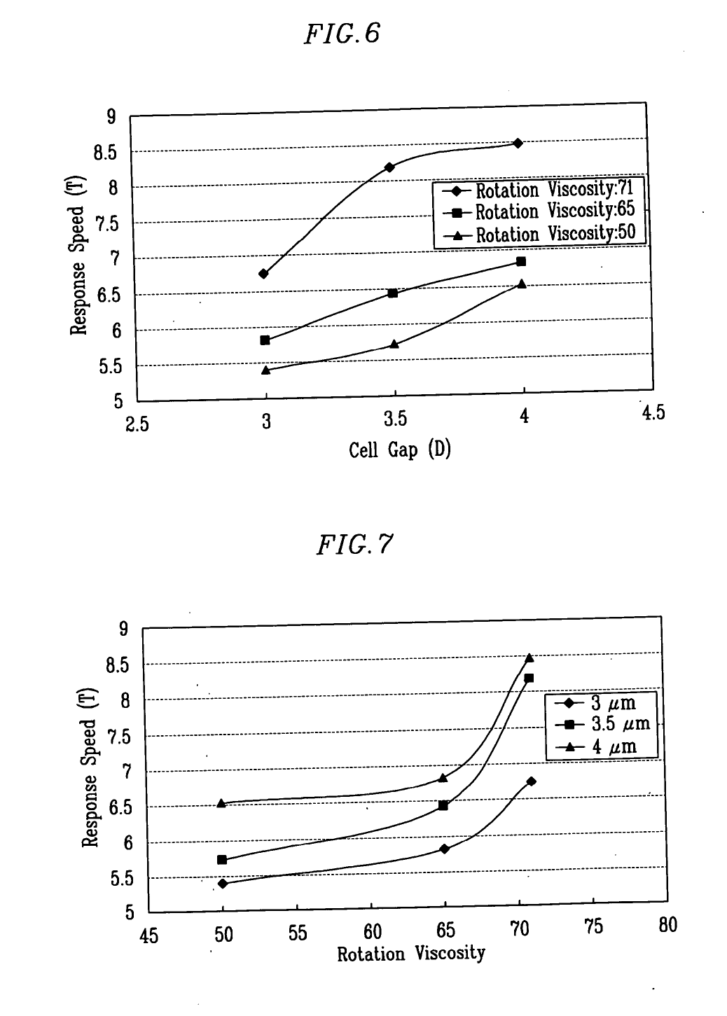

FIG. 5 shows a table of response times of a liquid crystal layer according to a rotation viscosity and a cell gap of the LCD according to an example of experimentation of the present invention, and FIG. 6 is a graph showing the response times of a liquid crystal layer according to a change in the rotation viscosity and the cell gap according to example of experimentation of the present invention.

In order to measure the response time of the liquid crystal layer, ‘03-151’, ‘04-203’, and ‘05-152’ of Merck Co. were used in an experiment, in which the rotation viscosities of the liquid crystal layers were 75 mPas, 65 mPas, and 50 mPas, respectively, the voltage differences between the field generating electrodes 191 and 270 were within the range of 0.2V-6.0V, and the cell gaps were 3.0 μm, 3.5 μm and 4.0 μm, respectively.

As shown in FIGS. 5 and 6, as the rotation viscosity and the cell gap of the liquid crystals increased, the response time lengthened. Thus, it can be learned that the response time of a liquid crystal layer of an LCD can be reduced by decreasing the rotation viscosity and the cell gap.

The tendency of change in the response time according to the change in the rotation viscosity and the cell gap of the liquid crystals will now be described with reference to FIG. 7.

FIG. 7 is a graph showing a change in the response times of a liquid crystal layer according to a change in the rotation viscosity with respect to various cell gaps according to one example of experimentation of the present invention, using the results from FIGS. 5 and 6.

In FIG. 7, referring to the relationship between the cell gap and the response time, it is noted that as the cell gap is reduced, the response time is reduced regardless of the rotation viscosity. Referring to the relationship between the rotation viscosity and the response time, notably, when the rotation viscosity is reduced, the response time is considerably reduced, but when the rotation viscosity is small, especially when the rotation viscosity is smaller than about 60 mPas, the amount of reduction of the response time of the liquid crystal layer according to the reduction of the rotation viscosity is very small.

Thus, when the rotation viscosity is smaller than 60 mPas, in order to reduce the response time, it is desirable to reduce the cell gap, rather than to use a liquid crystal material having a lower rotation viscosity.

The response times (t) according to each cell gap (d) with respect to each rotation viscosity value based on data obtained through several experimentations is as follows.

When the rotation viscosity is 75 mPas, t=−2.3×d²+17.83×d−26.04.

When the rotation viscosity is 65 mPas, t=−0.42×d²+3.95×d−2.25.

When the rotation viscosity is 50 mPas, t=0.95×d²−5.525×d+13.43.

When the relationship among the rotation viscosity, the cell gap, and the response time is expressed by an equation based on the data obtained from the results of the experimentations, the response time may be obtained from the expression 6.78+(rotation viscosity)×0.81+(cell gap)×0.7+(rotation viscosity)×(cell gap)×0.14.

Thus, in order to have a high speed response time of a liquid crystal layer of an LCD of about 5 ms, if the rotation viscosity of the liquid crystal layer of the LCD is greater than 75 mPas, the cell gap is preferably 3.2 μm or smaller, if the rotation viscosity of the liquid crystal layer of the LCD is greater than 65 mPas, the cell gap is preferably 3.2 μm or smaller, and if the rotation viscosity of the liquid crystal layer of the LCD is 50 mPas or greater, the cell gap is preferably 3.8 μm or smaller.

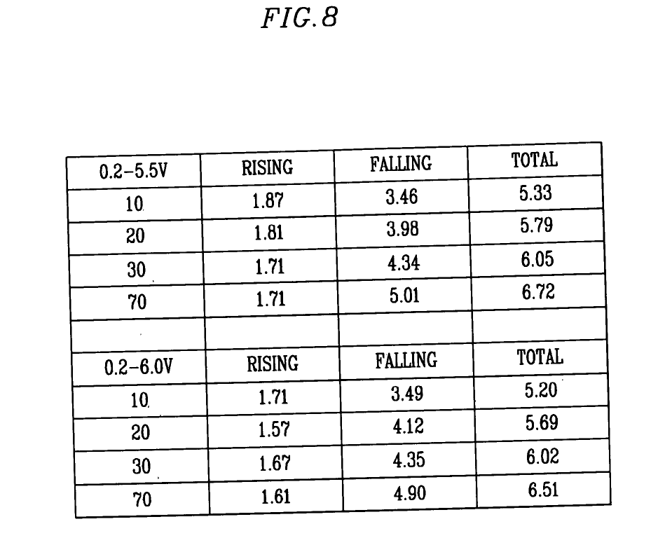

FIG. 8 shows a table of response times of a liquid crystal layer according to the pitch of the liquid crystal layer 3 of the LCD according to one example of experimentation of the present invention.

In order to measure the response time of a liquid crystal layer, ‘04-1035’ of Merck Co. was used, and the experimentation was carried out for two cases: one where the rotation viscosity of the liquid crystal layer was 76.5 mPas, the cell gap was 4.0 μm, and a voltage difference of the field generating electrodes was 0.2V-5.5V; and another where the rotation viscosity of the liquid crystal layer was 76.5 mPas, the cell gap was 4.0 μm, and a voltage difference of the field generating electrodes was 0.2V-6.0V.

As shown in FIG. 8, in the experimentation, as the pitch of the liquid crystal layer was increased, the response time lengthened. In addition, when the voltage difference between the field generating electrodes was increased, the response time was shortened. Accordingly, it can be recognized that by reducing the pitch of the liquid crystal layer or by increasing the voltage difference between the field generating electrodes, the response time of the liquid crystal layer can be reduced.

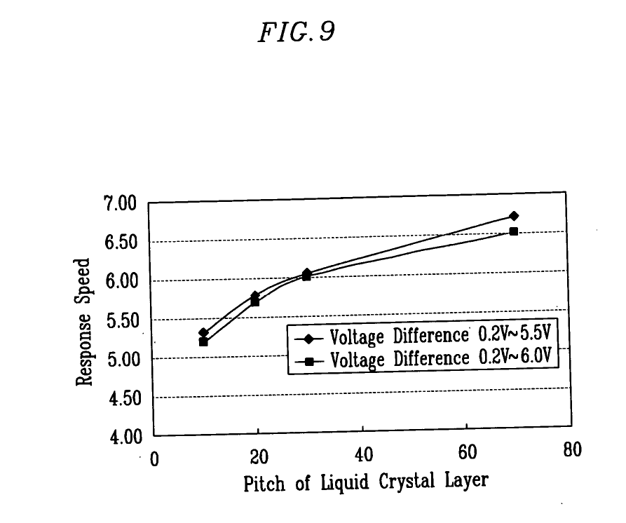

The tendency of the change in the pitch of the liquid crystal layer and the response time according to the voltage difference between the field generating electrodes will now be described with reference to FIG. 9.

FIG. 9 is a graph showing the change in the response times according to a change in the pitch of the liquid crystal layer in the experimentation of the present invention in FIG. 8.

With reference to FIG. 9, when the pitch of the liquid crystal layer is within the range of 10 μm to 30 μm, the response time is greatly increased according to the increase in the pitch of the liquid crystal layer, while when the pitch of the liquid crystal layer is within the range of 30 μm-70 μm, the response time is not significantly increased in relation to the increase in the pitch of the liquid crystal layer. In addition, when the pitch of the liquid crystal layer increases within the range of 10 μm-30 μm, a difference of the response times according to the voltage difference between the field generating electrodes is reduced, while when the pitch of the liquid crystal layer increases within the range of 30 μm-70 μm, the difference of the response times according to the voltage difference between the field generating electrodes is increased.

The response times (t) according to each pitch (P) of the liquid crystal layer with respect to the voltage difference between the field generating electrodes can be expressed by an equation based on the data obtained through the experimentation, as follows.

When the voltage difference between the field generating electrodes is within the range of 0.2V to 5.5V and the pitch of the liquid crystal layer is within the range of 10 μm to 30 μm, t=0.0364×P+4.9928.

When the voltage difference between the field generating electrodes is within the range of 0.2V to 5.5V and the pitch of the liquid crystal layer is within the range of 30 μm to 70 μm, t=0.0166×P+5.5558.

When the voltage difference between the field generating electrodes is within the range of 0.2V to 6.0V and the pitch of the liquid crystal layer is within the range of 10 μm to 30 μm, t=0.0408×P+4.8189.

When the voltage difference between the field generating electrodes is within the range of 0.2V to 6.0V and the pitch of the liquid crystal layer is within the range of 30 μm to 70 μm, t=0.0123×P+5.6467.

The contrast ratio of the screen according to the pitch of the liquid crystal layer or the voltage difference between the electrodes 191 and 270 will be described in the following.

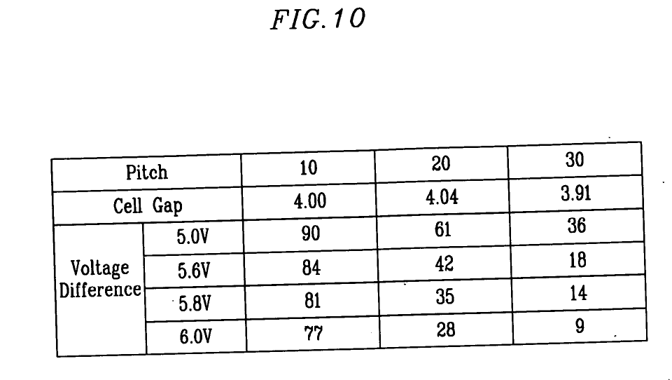

FIG. 10 is a table showing changes in the contrast ratio of the screen according to the pitch of the liquid crystal layer and the voltage difference between the field generating electrodes in one experimentation of the present invention. The same liquid crystal material as used in the tests represented FIGS. 8 and 9 was used in the present experimentation.

In the present experimentation, the contrast ratio of the screen was first measured in a case where the pitch of the liquid crystal layer was 70 μm and the cell gap was 4.04 μm, and then, the contrast ratio of the screen was measured in a case where the pitches of the liquid crystal layer were 10 μm, 2 μm, and 30 μm and the cell gaps were 0.00 μm, 4.04 μm, and 3.91 μm, respectively. Thereafter, the obtained values were compared to measure a reduction rate (%) of the contrast ratio. Respective voltage differences between the field generating electrodes were 0.2V-5V, 0.2V-5.6V, 0.2V-5.8V, and 0.2V-6V.

As noted in FIG. 10, the smaller the pitch of the liquid crystal layer and the voltage difference between the field generating electrodes are, the more the reduction rate of the contrast ratio of the LCD is increased.

That is, it is noted that when the pitch of the liquid crystal layer is reduced, the response time of the liquid crystal layer of the LCD shortens, but in this case, the contrast ratio of the screen of the LCD is also reduced. In addition, when the voltage difference between the field generating electrodes of the LCD is increased, the response time of the liquid crystal layer can be reduced and the contrast ratio of the screen of the LCD is also relatively increased.

Therefore, in order to reduce the response speed while sustaining the contrast ratio of the screen of the LCD, notably, it is desirable to sustain the voltage difference between the field generating electrodes above a certain value according to the pitch of the liquid crystal layer.

When the ranges of the pitch of the liquid crystal layer and the voltage difference between the field generating electrodes for securing the contrast ratio of 500:1 and 600:1 and the response time of 5 ms are obtained, it can be noted that, in order to have the contrast ratio of 500:1 or greater and the response time of 5 ms, if the pitch of the liquid crystal layer is 20 μm, a maximum voltage difference between the electrodes 191 and 270 is preferably 5.8V or greater, and if the pitch of the liquid crystal layer is 30 μm, a maximum voltage difference between the electrodes 191 and 270 is preferably 5.4V or greater.

In addition, in order to have the contrast ratio of 600:1 or greater and the response time of 5 ms, it can be noted that, preferably, the pitch of the liquid crystal layer is 30 μm and the maximum voltage difference between the electrodes 191 and 270 is 5.6 or greater.

As described above, by controlling the rotation viscosity and the cell gap of the LCD or by controlling the pitch of the liquid crystal layer or the voltage difference between the field generating electrodes of the LCD, a high speed response LCD with a response time of about 5 ms can be accomplished.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display (LCD) comprising:
a first electrode;
a second electrode facing the first electrode; and
a liquid crystal layer interposed between the first and second electrodes and having a twisted nematic alignment of liquid crystals,
wherein rotation viscosity of the liquid crystal layer is within a range of about 50 mPas to about 80 mPas, a cell gap defining a thickness of the liquid crystal layer is within a range of about 2.5 μm to about 5.0 μm, and a voltage difference between the first and second electrodes is within a range of about 0.2V to about 8.0V.

2. The LCD of claim 1, wherein the rotation viscosity is about 75 mPas and a response time of the liquid crystal layer is determined by the expression −2.3×(cell gap)²+17.83×(cell gap)−26.04.

3. The LCD of claim 1, wherein the rotation viscosity is about 65 mPas and a response time of the liquid crystal layer is determined by the expression −0.42×(cell gap)²+3.95×(cell gap)−2.25.

4. The LCD of claim 1, wherein the rotation viscosity is about 50 mPas and the response time of the liquid crystal layer is determined by the expression 0.95×(cell gap)²−5.525×(cell gap)+13.43.

5. The LCD of claim 1, wherein the first electrode comprises:
a first substrate;
a gate line and a data line formed on the first substrate;
a thin film transistor (TFT) connected with the gate line and the data line; and
a pixel electrode connected with the TFT.

6. The LCD of claim 1, wherein the second electrode comprises:
a second substrate;
a color filter formed on the second substrate; and
a common electrode formed on the color filter.

7. The LCD of claim 10, wherein the second electrode further comprises a light blocking member formed on the second substrate.

8. A liquid crystal display (LCD) comprising:
a first electrode;
a second electrode facing the first electrode; and
a liquid crystal layer interposed between the first and second electrodes and having a twisted nematic alignment of liquid crystals,
wherein rotation viscosity of the liquid crystal layer is within a range of about 50 mPas to about 80 mPas, a cell gap defining a thickness of the liquid crystal layer is within a range of about 2.5 μm to about 5.0 μm, a voltage difference between the first and second electrodes is within a range of about 0.2V to about 8.0V, and a response time is determined by the expression 6.78+(rotation viscosity)×0.81+(cell gap)×0.7+(rotation viscosity)×(cell gap)×0.14.

9. The LCD of claim 8, wherein the rotation viscosity of the liquid crystal layer is within the range of about 50 mPas to about 65 mPas and the cell gap is within the range of about 3.2 μm to about 3.8 μm.

10. The LCD of claim 8, wherein the rotation viscosity of the liquid crystal layer exceeds about 65 mPas, but is not greater than about 75 mPas, and the cell gap is about 2.6 μm or greater, but smaller than about 3.2 μm.

11. The LCD of claim 8, wherein the rotation viscosity of the liquid crystal layer is within the range of about 75 mPas to about 80 mPas and the cell gap is about 2.5 μm or greater, but smaller than about 2.6 μm.

12. A liquid crystal display (LCD) comprising:
a first electrode;
a second electrode facing the first electrode; and
a liquid crystal layer interposed between the first and second electrodes and having a twisted nematic alignment of liquid crystals,
wherein a pitch of the liquid crystal layer is within a range of about 10 μm to about 70 μm, a cell gap defining a thickness of the liquid crystal layer is within a range of about 3.0 μm to about 4.5 μm, and a voltage difference between the first and second electrodes is within a range of about 0.2V to about 6.0V.

13. The LCD of claim 12, wherein the voltage difference between the first and second electrodes is within the range of about 0.2V to about 5.5V, the pitch of the liquid crystal layer is within the range of about 10 μm to about 30 μm, and a response time of the liquid crystal layer is determined by the expression 0.0364×pitch+4.9928.

14. The LCD of claim 12, wherein the voltage difference between the first and second electrodes is within the range of about 0.2V to about 5.5V, the pitch of the liquid crystal layer is within the range of about 30 μm to about 70 μm, and the response time of the liquid crystal layer is determined by the expression 0.0166×pitch+5.5558.

15. The LCD of claim 12, wherein the voltage difference between the first and second electrodes is within the range of about 0.2V to about 6.0V, the pitch of the liquid crystal layer is within the range of about 10 μm to about 30 μm, and the response time of the liquid crystal layer is determined by the expression 0.0408×pitch+4.8189.

16. The LCD of claim 12, wherein the voltage difference between the first and second electrodes is within the range of about 0.2V to about 6.0V, the pitch of the liquid crystal layer is within the range of about 30 μm to about 70 μm, and the response time of the liquid crystal layer is determined by the expression 0.0123×pitch+5.6467.

17. The LCD of claim 12, wherein the pitch of the liquid crystal layer is about 20 μm, the contrast ratio of a screen is about 500:1, and a maximum voltage difference between the first and second electrodes is greater than about 5.8V.

18. The LCD of claim 12, wherein the pitch of the liquid crystal layer is about 30 μm, the contrast ratio of a screen is about 500:1, and the maximum voltage difference between the first and second electrodes is greater than about 5.4V.

19. The LCD of claim 12, wherein the pitch of the liquid crystal layer is about 30 μm, the contrast ratio of a screen is about 600:1, and the maximum voltage difference between the first and second electrodes is greater than about 5.6V.

20. The LCD of claim 12, wherein the first electrode comprises:
a first substrate;
a gate line and a data line formed on the first substrate;
a thin film transistor (TFT) connected with the gate line and the data line; and
a pixel electrode connected with the TFT.

21. The LCD of claim 12, wherein the second electrode comprises:
a second substrate;
a color filter formed on the second substrate; and
a common electrode formed on the color filter.

22. The LCD of claim 21, wherein the second electrode further comprises a light blocking member formed on the second substrate.
